(19) United States
(12) Patent Application Publication
(10) Pub. No.: US 2022/0114602 A1
(43) Pub. Date: Apr. 14, 2022

(54) DYNAMIC CUSTOMIZATION OF A CUSTOMER EXPERIENCE BASED ON COGNITIVE COMPUTING

(71) Applicant: Wells Fargo Bank, N.A., San Francisco, CA (US)

(72) Inventors: James F. Horn, III, Alton, IL (US); Jimmie Lenz, Isle of Palms, SC (US)

(21) Appl. No.: 15/625,091

(22) Filed: Jun. 16, 2017

Related U.S. Application Data
(60) Provisional application No. 62/492,815, filed on May 1, 2017.

(51) Int. Cl. G06Q 30/02; G06Q 50/00

(52) U.S. Cl. CPC G06Q 30/0201; G06Q 30/016; G06Q 50/01

(57) ABSTRACT

A financial institution computing system includes a contextual data analysis circuit and a service customization circuit. The contextual data analysis circuit is configured to receive a message from a user device of a customer. The contextual data analysis circuit is further configured to extract contextual data from the received message. The contextual data analysis circuit is further configured to determine one or more of an emotional state of the customer and a reason for the message based on the extracted contextual data of the message. The service customization circuit is configured to perform a financial service for the customer based on at least one of the determined emotional state of the customer and the reason for the message.

### CROSS-REFERENCE TO RELATED APPLICATIONS

This application claims priority to U.S. Provisional Patent Application No. 62/492,815 entitled “DYNAMIC CUSTOMIZATION OF A CUSTOMER EXPERIENCE BASED ON COGNITIVE COMPUTING,” filed on May 1, 2017, which is herein incorporated by reference in its entirety and for all purposes.

### BACKGROUND

A financial institution provides a multitude of services to customers, such as, providing financial documents or statements to the customer reflecting financial information (e.g., about the customer's financial accounts associated with the financial institution). The financial document or statement may be generated in response to a request by the customer. In some instances, the financial documents or statements are automatically generated by the financial institution and provided to the user on a periodic basis. However, these statements and documents sometimes are challenging for a customer to comprehend, and make it difficult to locate the precise information the customer desires (e.g., because a financial document includes too much superfluous information not pertinent to the customer's request). Further, the customer may want additional information or differently formatted data shown in the documents or statements.

### SUMMARY

According to various embodiments, a financial institution computing system includes a contextual data analysis circuit and a service customization circuit. The contextual data analysis circuit is configured to receive a message from a user device of a customer. The contextual data analysis circuit is further configured to extract contextual data from the received message. The contextual data analysis circuit is further configured to determine one or more of an emotional state of the customer and a reason for the message based on the extracted contextual data of the message. The service customization circuit is configured to perform a financial service for the customer based on one or more characteristics of the message.

According to various embodiments, there is provided a method performed by a financial institution computing system. The method includes receiving, by a contextual data analysis circuit, a message from a user device of a customer. The method further includes extracting, by the contextual data analysis circuit, contextual data from the received message. The method further includes determining, by the contextual data analysis circuit, one or more of an emotional state of the customer and a reason for the message based on the extracted contextual data of the message. The method further includes performing, by a service customization circuit, a financial service for the customer based on at least one of the determined emotional state of the customer and the reason for the message.

According to various embodiments, there is provided a non-transitory computer readable media having computer-executable instructions embodied therein that, when executed by a contextual data analysis circuit and a service customization circuit of a financial institution computing system, causes the financial institution computing system to perform operations. The operations include receiving, by the contextual data analysis circuit, a message from a user device of a customer. The operations further include extracting, by the contextual data analysis circuit, contextual data from the received message. The operations further include determining, by the contextual data analysis circuit, one or more of an emotional state of the customer and a reason for the message based on the extracted contextual data of the message. The operations further include performing, by the service customization circuit, a financial service for the customer based on at least one of the determined emotional state of the customer and the reason for the message.

### BRIEF DESCRIPTION OF THE FIGURES

FIG. 1 is a block diagram illustrating a system for customizing financial services according to some embodiments.

FIG. 2 is a block diagram illustrating an example of the system for customizing financial services shown in FIG. 1 according to some embodiments.

FIGS. 3A-3C are diagrams illustrating generation of financial documents by a financial institution computing system according to some embodiments.

FIG. 4 is a flowchart of a method for customizing financial services according to some embodiments.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting. For example, various embodiments of systems and methods discussed herein may be relevant to any of a variety of circumstances where customizing financial services for a customer may be useful.

In various embodiments, systems and methods for customizing financial services are discussed herein. A financial institution may desire to improve customer satisfaction and customer user experience in connection with a request from a customer for a financial service. The financial institution accomplishes this by analyzing the customer's request for the substance of the request and for contextual data associated with the request. For example, in some embodiments, the customer requests a financial statement reflecting financial information about the customer's financial account, and the financial institution analyzes the request for the requested information and for contextual data (e.g., voice tone, sentence syntax, punctuation, diction, and so on). In response to the analysis, the financial institution can fulfill the request and provide the financial statement, and can also provide additional services based on the contextual data of the request.

As an example, in some embodiments, the financial institution provides the requested financial statement that includes only information that is pertinent to the customer's request, while excluding information that is not pertinent to the customer's request. The financial institution may determine what information is pertinent based on the request itself and on the contextual data of the request. For example, if the financial institution determines that the customer is only interested in incurred account fees, the financial institution can generate a financial statement that includes fee information, and little or no other account information. In addition, the financial institution can provide further financial services that are pertinent to the customer's request. For example, if a deadline for filing taxes is soon and the contextual data indicates that the customer is stressed or agitated, the financial institution can further provide, or offer to provide, tax-related services in response to the customer's request.

Accordingly, analyzing contextual data of a customer's request for a financial service allows a financial institution to provide the customer with customized financial services based on the customer's needs and preferences, and allows the financial institution to predict or anticipate other customer's needs or preferences as well. As such, according to various embodiments, customer satisfaction and customer user experience are improved. In addition, by more precisely determining needs and anticipating future needs of a customer, the customer is less likely to make further requests (or instances of future requests may decrease from the customer) for financial services from the financial institution, thereby conserving computing resources of the customer and of the financial institution, and conserving network resources that are used to transmit requests and responses to requests between the customer and the financial institution (e.g., freeing up the network resources for other operations, and therefore providing reduced latency of the network). Furthermore, because the financial institution provides financial services (e.g., financial information) that the customer needs, and omits services and information that may be irrelevant to the customer, the amount of information sent over a network is reduced such that network bandwidth is conserved. Furthermore, in the situation where a customer requests financial information, by transmitting and displaying only information that is pertinent to the customer and the customer's request (e.g., by omitting information that is not pertinent to the customer), the information at a user device can be more efficiently displayed from a display space perspective, thereby conserving display space at the user device. For example, if the customer only requests certain items from a bank statement, the requested items can be more efficiently displayed in the limited display space of the mobile device than the entire bank statement. Accordingly, the embodiments described herein solve the technical and internet-centric problems of accurately and efficiently fulfilling requests for financial services by a financial institution.

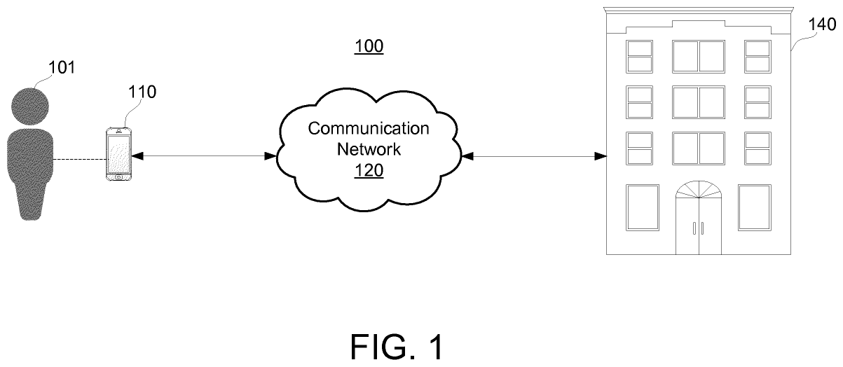

FIG. 1 is a diagram of a system 100 for customizing financial services for a customer 101 of a financial institution 140 according to some arrangements. Referring to FIG. 1, the customer 101 is an account holder of at least one financial account at the financial institution 140. The customer 101 is associated with a user device 110. That is, the customer 101 can use the user device 110 to access financial products and/or services provided by the financial institution 140. Particularly, the customer 101 can make financial transactions (e.g., payments, deposits, or the like) with another party using the user device 110 or via another suitable method. As another example, the customer 101 can request, using the user device 110, other financial services from the financial institution 140, such as, requesting financial statements or documents reflecting information of financial accounts held by the customer with the financial institution 140. In some embodiments, the user device 110 is any device that the customer 101 uses to access information from the financial institution, such as, but not limited to, a telephone, a mobile device (e.g., smartphone), a personal computer (e.g., laptop or desktop), an automatic teller machine (ATM), an automatic banking machine (ABM), or any other suitable user-owned or non-user-owned device.

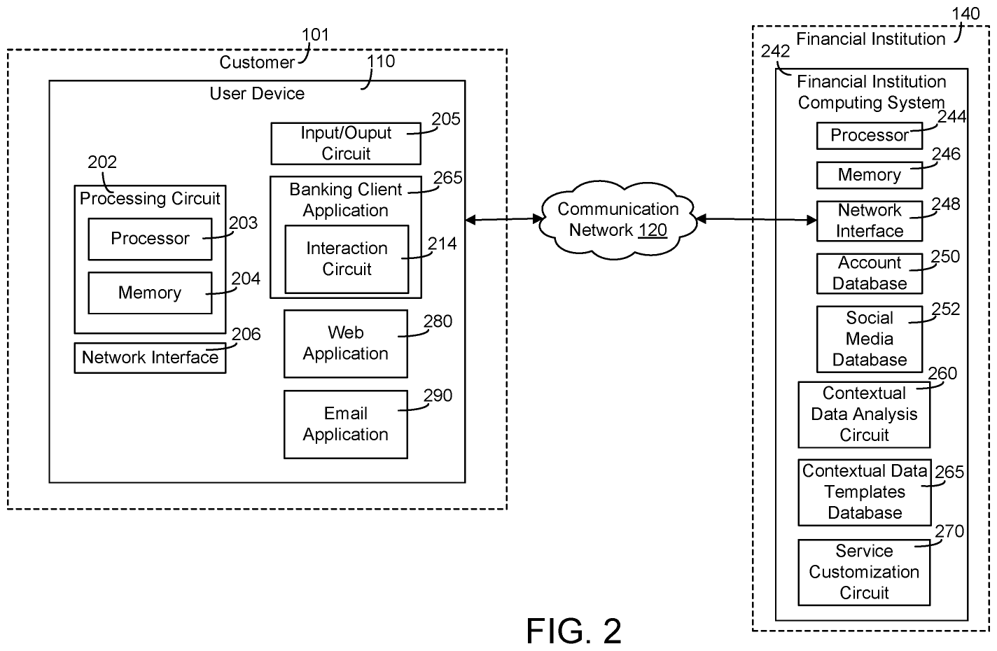

The user device 110 is connected to the financial institution 140 (e.g., a financial institution computing system 242 of FIG. 2) via a communication network 120. The communication network 120 is any suitable Local Area Network (LAN) or Wide Area Network (WAN). For example, the communication network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The communication network 120 is structured to permit the exchange of data, values, instructions, messages, and the like between the user device 110 and the financial institution 140 (e.g., a financial institution computing system 242 of FIG. 2). Example interactions between the customer 101 and the financial institution 140 include, but are not limited to, accessing a financial statement with respect to a financial account of the customer 101.

FIG. 2 is a block diagram illustrating an example of the system 100 for customizing financial services shown in FIG. 1, according to some embodiments. FIG. 2 illustrates a diagram of an example of the user device 110 and an example of the financial institution 140 in the system 100 set forth in FIG. 1, according to some embodiments. Referring now to FIGS. 1-2, the financial institution 140 includes one or more of a bank branch, loan office, mortgage office, financial services office, retail office, automatic teller machine (ATM) location, a web interface (e.g., for online banking), a remote server (e.g., an online bank), a combination thereof, and/or the like. The financial institution 140 provides financial products and services such as, but not limited to, credit card accounts, checking/saving accounts, retirement accounts, mortgage accounts, loan accounts, investment and financial accounts, and the like to the customer 101. The financial institution may further provide services such as investment services, tax services, accounting services, and the like.

The financial institution 140 has at least one associated financial institution computing system 242. In some embodiments, the financial institution 140 includes a plurality of financial institution computing systems 242 (e.g., each one configured to perform a different function or operation). The financial institution computing system 242 may provide access to one or more of the services or products described above. The financial institution computing system 242 includes a processor 244 and a memory device 246. The processor 244 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 246 is or includes tangible, non-transient volatile memory or non-volatile memory. In this regard, the memory 246 stores programming logic that, when executed by the processor 244, controls the operations of the financial institution computing system 242. In some arrangements, the processor 244 and the memory 246 form various processing circuits described with respect to the financial institution computing system 242 (e.g., the contextual data analysis circuit 260 and the service customization circuit 270).

As shown, the financial institution computing system 242 includes a network interface 248. The network interface 248 is structured for sending and receiving data over the communication network 120 (e.g., to and from the user device 110, etc.). Accordingly, the network interface 248 includes any of a cellular transceiver (for cellular standards), local wireless network transceiver (for 802.11X, ZigBee, Bluetooth, Wi-Fi, or the like), wired network interface, combination thereof (e.g., both a cellular transceiver and a Bluetooth transceiver), and/or the like.

The financial institution computing system 242 includes an account database 250 that stores customer information and account information relating to one or more accounts held by customers of the financial institution 140. In some embodiments, the account database 250 stores account information of brokerage accounts held by customers of the financial institution 140. The account information stored in the account database 250 includes asset allocation, valuation of the whole or portions of an account (e.g., valuation of particular assets), deposit and withdrawal information, transaction history (e.g., including type of asset purchased or sold, value of the asset, and so on), dividends earned, fees charged to the account, gains and losses of assets of the account, customer service information (e.g., information pertaining to the financial institution 140), and so on. The account database 250 may further store account information related to savings accounts, checking accounts, health savings accounts, credit card accounts, or other financial accounts held by a customer of the financial institution.

The financial institution computing system 242 includes a social media database 252 for storing information pertaining to social media accounts associated with customers of the financial institution 140. The social media database 252 can store various pieces of data retrieved from the social media accounts of the customers of the financial institution 140, such as, but not limited to, social media posts made by customers (e.g., posts indicating a sentiment towards the financial institution 140, posts indicating major life events, and the like), social connections (e.g., friends list, number of friends, and so on), life events (e.g., upcoming birthdays, anniversaries, marital status, and so on), and the like. In some embodiments, the social media database 252 may communicate with the one or more social media accounts of the customer via an application program interface (API).

The financial institution computing system 242 includes a contextual data analysis circuit 260. The contextual data analysis circuit 260 is capable of retrieving and analyzing contextual data associated with the customers of the financial institution 140. In some embodiments, the contextual data analysis circuit 260 receives contextual data from the customer 101. The contextual data can include a tone of voice (e.g., captured when the customer 101 is interacting with the financial institution 101 over the phone, when the customer is interacting with an ATM or branch teller, and the like), body language (e.g., captured by a camera at an ATM or in a branch office of the financial institution 140), syntax of words of the customer 101 (e.g., messages or emails sent electronically by the customer 101 to the financial institution 140, verbal syntax, and the like), diction (e.g., textual or verbal), facial expressions, volume of the voice of the customer 101, use of punctuation and capitalization of words used by the customer 101, and so on. Contextual data regarding a customer's social media activity is further described below (e.g., extraction of the social media contextual data by the contextual data analysis circuit 260 and storage of the extracted data in the social media database 252).

The contextual data analysis circuit 260 is operatively coupled to one or more of the components of the financial institution computing system 242. For example, the contextual data analysis circuit 260 is coupled to the network interface 248 for communicating with the user device 110 via the communication network 120. In some embodiments, the contextual data analysis circuit 260 receives contextual data via the communication network 120 indicating an emotional state of the customer 101 based on an interaction with the financial institution 140 by the customer 101, or a reason why the customer 101 is requesting a particular financial service. For example, the customer 101 can access the financial institution via the user device 110 (or via other ways that a customer can interact with the financial institution 140, such as, but not limited to, an ATM, a teller at a branch of the financial institution 140, a telephonic or web-based virtual assistant, an electronic message, and the like). While the customer 101 is interacting with the financial institution 140 (e.g., while the customer 101 is requesting a financial service from the financial institution 140), the contextual data analysis circuit 260 monitors and analyzes cues from the customer 101 to determine a emotional state of the customer 101 or a reason why the customer 101 is requesting a particular financial service. Example requested financial services may include generating a financial statement or document reflecting information of an account of the customer 101 (e.g., a brokerage account), reversing a fee charged by the financial institution 101, opening a new account, depositing or withdrawing funds with an account, modifying investment allocation of assets of an account, or any other various financial services of the financial institution 140.

In some embodiments, the received contextual data is extracted by the contextual data analysis circuit 260. For example, the contextual data analysis circuit 260 may extract words and sentences from a message from the customer 101, or extract volume data and transcriptions from a voice message. In some embodiments, the contextual data analysis circuit 260 parses, analyzes, or otherwise interprets the received and extracted contextual data to determine an emotional state of the customer 101 or a reason why the customer 101 is making a particular request for a financial service from the financial institution 140. For example, the contextual data may include disparaging words, exclamation points, and excessive capitalization of letters that were extracted from an e-mail or other digital message received from the customer. The contextual data analysis circuit 260 may then analyze the received contextual data to determine that the customer is potentially in an angry or agitated emotional state. Similarly, in some embodiments, the contextual data includes video and audio data of the customer 101 speaking at a high volume and/or using disparaging words, and contemporaneously presenting numerous instances of gesticulations. The contextual data analysis circuit 260 can interpret the customer's 101 emotional state as being angry or agitated. In some embodiments, the contextual data analysis circuit 260 analyzes the contextual data to identify other emotional states of the customer 101, such as, but not limited to, the customer 101 being nervous, sad, excited, happy, aggravated, confused, calm, complacent, cynical, disappointed, frustrated, satisfied, uncomfortable, and the like. As another example, the contextual data analysis circuit 260 may detect a consistent volume level of speech of the customer 101 and minimal body movement or relaxed body posture, and so the contextual data analysis circuit 260 may determine that the customer 101 is in a satisfied or content emotional state. As yet another example, the contextual data analysis circuit 260 may detect particular words used by the customer such as “wow” or “awesome,” and so the contextual data analysis circuit 260 may determine that the customer is in an excited emotional state.

In some embodiments, the contextual data analysis circuit 260 analyzes the received contextual data by comparing the contextual data with stored templates in a contextual data templates database 265 that indicate behaviors that correlate to particular emotional states. The contextual data templates are stored in the financial institution computing system 242 for access and lookup by the contextual data analysis circuit 260. For example, if the received contextual data includes the customer 101 using a particular word or phrase, the contextual data analysis circuit 260 accesses the contextual data templates database to cross-reference that word or phrase with an emotional state (e.g., the sentence “I don't understand” with the emotional state “confusion”). In some embodiments, the contextual data analysis circuit 260 parses sentences of the user (e.g., after transcribing the sentences, if the customer 101 is speaking verbally) into words or phrases for lookup in the contextual data templates database. Similarly, in some embodiments, the contextual data templates database stores volume thresholds indicating certain emotional states (e.g., if the volume of the voice of the customer 101 is above a decibel threshold, the customer 101 can be determined to be angry, or if below another threshold, the customer 101 can be determined to be sad or nervous), specific body language indicating an emotional state (e.g., hands thrown up in the air can be determined to indicate anger or frustration, shoulder shrugging can be determined to indicate confusion, etc.), punctuation or capitalization of sentences indicating an emotional state (e.g., excessive exclamation points indicate anger or excitement), and so on.

In some embodiments, the contextual data analysis circuit 260 is coupled to one or more of the account database 250 or social media database 252 to access information stored thereon with respect to account information and social media data of customers of the financial institution 140 to determine an emotional state during a request, or a reason for a request by the customer 101. In some embodiments, the contextual data analysis circuit 260 parses the account database 250 to access an account of the customer 101 (e.g., a brokerage account) and information associated with the account of the customer 101 (e.g., time and date of a transaction, fees incurred, valuations of assets, fluctuations of investment values over time, dividends received, and so on). In some embodiments, the contextual data analysis circuit 260 utilizes the account information to help in determining an emotional state of the customer 101. For example, if it is detected that the customer 101 has recently been charged an account fee, the contextual data analysis circuit 260 determines that the customer 101 is in an agitated or angry emotional state.

In some embodiments, the contextual data analysis circuit 260 determines one or more social media accounts associated with the customer 101 of the financial institution 140 (e.g., by the customer 101 providing the financial institution 140 with their social media account information), and parses information of the social media accounts to retrieve relevant information for storing in the social media database 252. For example, the contextual data analysis circuit 260 retrieves a social media account link associated with the customer 101, accesses the link, parses the resulting social media account for relevant information, and stores the relevant information in the social media database 252. In some embodiments, the financial institution computing system 242 requests identification of one or more social media accounts of the customer 101, for example, by asking for links to one or more social media accounts of the customer 101. The financial institution computing system 242 may further request permission to access one or more social media accounts associated with the customer 101, and may also request the customer 191 provide log-in information for the social media accounts (e.g. user name and password). In other embodiments, the financial institution computing system 242 performs internet searches for social media accounts of the customer 101, and can verify that a social media account belongs to the customer 101 by requesting the customer to confirm the social media account or by comparing information described by the social media account with known information of the customer 101 (e.g., an address, an age, and so on).

Relevant information includes information about the customer 101 relevant to determining a reason for a request of the customer 101, or an emotional state of the customer 101 during the request. Examples of the relevant information may include, social media postings indicating an emotional state, birthdays, life events (e.g., wedding, birth of a child, passing away of a family member or friend, and the like), location information of the customer 101, and so on. In some embodiments, the contextual data analysis circuit 260 determines whether information of a social media account of the customer 101 is relevant information, for example, by the number of responses (e.g., likes or comments) that a social media posting has, the language of a social media posting (e.g., language indicating a child birth, mentioning of the financial institution 140, and so on), and the like. For example, the contextual data analysis circuit 260 can parse the customer's 101 social media account for a recent posting indicating that the customer 101 is not happy with the financial institution 140, and the contextual data analysis circuit 260 can then determine that the customer 101 is in an angry or frustrated emotional state. Similarly, the contextual data analysis circuit 260 can determine a reason for the customer 101 initiating a request of the financial institution 140. For example, if the customer 101 indicates on their social media account complaining about excessive fees occurred in the customer's account, the contextual data analysis circuit may determine that a customer may be requesting information from the financial institution 140 to better investigate the fees associated with one or more accounts of the customer 101.

As another example, the contextual data analysis circuit 260 can determine that the customer 101 is expecting a child based on information extracted from one or more social media accounts of the customer 101, and the contextual data analysis circuit 260 can then determine that the customer 101 is interested in financial services related to this life event (e.g., opening a college fund for the child, seeking a loan to buy a house, and the like). As yet another example, the contextual data analysis circuit 260 can determine from one or more social media postings of the customer 101 that the customer 101 is researching other financial institutions to conduct business with. The contextual data analysis circuit 260 can then determine that the customer 101 is in a hostile or otherwise unhappy emotional state and that a reason for the customer 101 communicating with the financial institution is to close an account or redirect funds. In some embodiments, the contextual data analysis circuit 260 monitors contextual data of the customer 101 (e.g., by monitoring social media postings of the customer 101), and can determine an underlying reason as to why the customer 101 wishes to close an account based on contextual data collected from an interaction with the customer 101, or from a social media account of the customer 101. In some embodiments, if the contextual data analysis circuit 260 determines that the customer 101 may want to close an account with the financial institution 140, the contextual data analysis circuit can alert the financial institution 140 to allow the financial institution 140 to perform preemptive actions in response. For example, the customer 101 may be determined to be angry towards the financial institution 140 based on the contextual data, and the financial institution 140 can attempt to remedy the reason why the customer 101 is angry so that the customer 101 is no longer angry). In other examples, the financial institution 140 may provide incentives or other benefits to the customer 101 to prevent them from closing the account.

In some embodiments, the contextual data analysis circuit 260 can determine a level of influence of the customer 101 based on social media presence. For example, the contextual data analysis circuit 260 may flag or otherwise identify a social media account of a customer 101 that is designated as having a special or elite status (e.g., as designated by a social media website or network). As another example, the contextual data analysis circuit 260 can categorize a social media account as having high influence based on the activity of the social media account (e.g., an account that is very active with postings, reviews, and the like), based on the number of connections associated with the account (e.g., an account that has a high number of friends), and the like. In some embodiments, the contextual data analysis circuit 260 determines whether the customer 101 has high influence on social media and can thus allow the financial institution 140 to provide specialized or higher priority to the customer 101 that has the high influence, as opposed to a customer 101 that has relatively lower influence on social media.

The financial institution computing system 242 includes a service customization circuit 270. The service customization circuit 270 is capable of customizing financial services for the customers of the financial institution 140. The service customization circuit 270 is operatively coupled to one or more of the components of the financial institution computing system 242. For example, the service customization circuit 270 is coupled to the network interface 248 for communicating with the user device 110 via the communication network 120. In addition, the service customization circuit 270 is coupled to the contextual data analysis circuit 260 to receive results determined by the contextual data analysis circuit 260 (e.g., the emotional state of the customer 101 and/or an estimated reason for the customer 101 contacting the financial institution 140). In one embodiment, the service customization circuit 270 is configured to customize financial services for the customer 101 based on the results determined by the contextual data analysis circuit 260.

In some embodiments, the service customization circuit 270 modifies a financial statement or document requested by the customer 101 in response to the actual request by the customer 101 and the contextual data associated with the request that has been analyzed by the contextual data analysis circuit 260. For example, a customer 101 may call or otherwise communicate with the financial institution 140 to complain that the financial statement corresponding to an account of the customer 101 is too difficult or confusing to read as there is too much superfluous information in the statement. The customer 101 may also indicate that they want to see any fees incurred that are associated with one or more accounts of the customer 101. As such, the service customization circuit 270 can prepare a financial statement reflecting the fees associated with the account, and depending on the emotional state of the customer 101 determined by the contextual data analysis circuit 260, the service customization circuit 270 can further modify the information (e.g., information related to the fees, such as, other losses incurred in the account, the type of fees incurred, the date of the fees, and so on) provided on the financial statement or simply maintain the fee information only in the financial statement. For example, if the contextual data analysis circuit 260 determines the emotional state of the customer as being irate, the service customization circuit 270 can refrain from adding any extra information in the financial statement to reduce the risk of further irritation to the customer 101. Alternatively, the service customization circuit may provide a detailed breakdown of the fees for the user, while remove other information from the statement, to also reduce the risk of further irritating the customer. However, for example, if the contextual data of the customer 101 is analyzed to indicate that the emotional state of the customer 101 is calm, the service customization circuit 270 can add more information to the financial statement than just the fee information (e.g., information supplemental to the fee information, such as, but not limited to, dates of the fees incurred, amounts of the fees, types of fees, expense ratio of investments, and the like). In some embodiments, the initial request for financial service is received and processed by the contextual data analysis circuit 260 for analyzing contextual data of the request to be used by the service customization circuit 270 to customize financial services for the customer 101 based on the analyzed contextual data, as described herein.

In some embodiments, the service customization circuit 270 provides financial information to the customer 101 via audio (e.g., as opposed to visually showing a financial statement). For example, in response to a request by the customer 101 for particular information regarding their financials, the service customization circuit 270 can audibly provide the specific information asked for (e.g., with little or no extra information), as described above (e.g., in response to a determined emotional state of the customer 101). For example, the user device 110 may be a device capable of fulfilling audio commands from the customer 101, and the customer 101 may request to hear financial information regarding their account. Accordingly, in response, the service customization circuit 270 can provide the requested information audibly through the user device 110, as described above with respect to visual presentation. Accordingly, a more natural customer service experience can be achieved between the customer 101 and the financial institution 140 (e.g., by the financial institution 140 providing precisely the information the customer 101 desires, rather than other superfluous information that would waste time in presenting the superfluous information audibly).

In some embodiments, the service customization circuit 270 routes a call from the customer 101 depending on the emotional state of the customer 101 determined by the contextual data analysis circuit 260. For example, if the customer 101 is determined to be angry, the service customization circuit 270 can route the call to particular agents or tellers that are more skilled in dealing with angry customers. In some embodiments, the contextual data analysis circuit 260 determines that the customer 101 is in a pleasant or otherwise happy emotional state, and, in response, the service customization circuit 270 can provide offers for other financial services, as the customer 101 is more likely to partake or purchase financial services when in a happy emotional state.

In some embodiments, after the contextual data analysis circuit 260 determines a reason for the customer 101 contacting the financial institution 140, the service customization circuit 270 can tailor services based on the determined reason. For example, if the customer 101 is determined to be calling to close an account, the service customization circuit 270 can prepare incentives or offers to entice the customer 101 to maintain the account.

In some embodiments, the service customization circuit 270 is configured to suggest other financial services to the customer 101 based on the determined reason for the request and/or the contextual data associated with the request. For example, the service customization circuit 270 can receive a reason for the customer 101 contacting the financial institution 140, as determined by the contextual data analysis circuit 260, and based on the determined reason of contact by the customer 101, the service customization circuit 270 can suggest additional financial services that would be beneficial to the customer 101. As an example, the contextual data analysis circuit 260 can determine that the customer 101 contacted the financial institution 140 to open an account for investing and/or saving money for a child. Based on the determination, the contextual data analysis circuit 260 determines that the customer 101 has at least one child, and provides that information to the service customization circuit 270. The service customization circuit can 270 receive this information from the contextual data analysis circuit 260, and suggest particular types of accounts beneficial for saving money for college tuition for a child (e.g., a Uniform Gift to Minors Account or a 529 account). In addition, the service customization circuit 270 may also suggest other financial products, such as mortgage options, trust accounts, and the like to the customer 101, based on the above determination.

In some embodiments, the service customization circuit 270 is configured to suggest financial services to the customer 101 based on historical data of customers requesting or receiving particular services under particular circumstances (e.g., based on historically similar customer requests). For example, the service customization circuit 270 suggests a financial service to the customer 101, and in addition the customization circuit 270 can also determine historically what other financial services that other customers have used or requested in connection with the suggested financial service. The service customization circuit 270 can suggest those other financial services that are historically connected to the originally suggested financial service. In some embodiments, the service customization circuit 270 maintains a database of financial services that have been historically suggested and used by customers, and the service customization circuit 270 cross-references these financial services to determine which ones are typically utilized together. In some embodiments, the service customization circuit 270 updates this database periodically to develop additional financial services that are typically used together. The service customization circuit 270 can then suggest those additional financial services to the customer 101. For example, the service customization circuit 270 can fulfill a request of the customer 101 to open a particular retirement account (e.g., a 401k account), and the service customization circuit 270 can access the database including historical data of customers that have that particular retirement account. The service customization circuit 270 can then cross-reference the particular retirement account to determine if many or most other customers also typically partake in other financial services (e.g., other retirement accounts, automatic deposits into the retirement account, particular assets purchased in retirement accounts, and so on), and the service customization circuit 270 can then suggest those additional financial services that are historically used in connection with the originally suggested financial service to the customer 101.

In some embodiments, the service customization circuit 270 is configured to suggest financial services based on other factors, such as, but not limited to, time of year, characteristics of the customer 101, and so on. As an example, if the customer 101 makes a request for a financial product or service (e.g., a breakdown of fees charged to an account of the customer 101) during tax season, the service customization circuit 270 can suggest additional products or services related to the tax season (e.g., providing tax return forms to the customer 101, showing tax-deductible charges to the customer 101, and the like). As another example, the age or gender of the customer 101 can be utilized to suggest additional products or services that are pertinent to the request and to the customer 101 (e.g., if the customer 101 is elderly, the service customization circuit 270 can suggest types of accounts or investments that are appropriate for someone who is likely to retire soon or who is retired).

As shown, the customer 101 operates or is associated with the user device 110. In some arrangements, the user device 110 includes a processing circuit 202 including a processor 203 and memory 204. The processor 203 is implemented as a general-purpose processor, an ASIC, one or more FPGAs, a DSP, a group of processing components that are distributed over various geographic locations or housed in a single location or device, or other suitable electronic processing components. The memory 204 (e.g., RAM, NVRAM, ROM, Flash Memory, hard disk storage, etc.) stores data and/or computer code for facilitating the various processes described herein. Moreover, the memory 204 is or includes tangible, non-transient volatile memory or non-volatile memory. Accordingly, the memory 204 includes database components, object code components, script components, or any other type of information structure for supporting the various activities and information structures described herein.

The user device 110 is shown to include various circuits and logic for implementing the activities described herein. More particularly, the user device 110 includes input/output circuit 205, network interface 206, banking client application 265, web application 280, email application 290, or the like, in addition to the processing circuit 202, described above. While various circuits, interfaces, and logic with particular functionality are shown, it should be understood that the user device 110 includes any number of circuits, interfaces, and logic for facilitating the functions described herein. For example, the activities of multiple circuits are combined as a single circuit and implemented on a same processing circuit (e.g., the processing circuit 202), as additional circuits with additional functionality are included, etc.

The network interface 206 is configured for and structured to establish a communication session via the communication network 120 with the financial computing system 242. Accordingly, the network interface 206 is an interface such as, but not limited to, the network interface 248.

The input/output circuit 205 is configured to receive user input from and provide information to the customer 101. In this regard, the input/output circuit 205 is structured to exchange data, communications, instructions, etc. with an input/output component of the user device 110. Accordingly, in some arrangements, the input/output circuit 205 includes an input/output device such as a display device, touchscreen, keyboard, microphone, and/or the like. In some arrangements, the input/output circuit 205 includes communication circuitry for facilitating the exchange of data, values, messages, and the like between the input/output device and the components of the user device 110. In some arrangements, the input/output circuit 205 includes machine-readable media for facilitating the exchange of information between the input/output device and the components of the user device 110. In still another arrangement, the input/output circuit 205 includes any combination of hardware components (e.g., a touchscreen), communication circuitry, and machine-readable media.

The banking client application 265 is a server-based application executable on the user device 110. In this regard, the customer 101 can first download the application prior to usage. In another arrangement, the banking client application 265 is coded into the memory 204 of the user device 110. In still another arrangement, the banking client application 265 is a web-based interface application. In this configuration, the customer 101 has to log onto or access the web-based interface before usage. For example, the customer 101 may access the web-based interface using an internet browser associated with the user device. In this regard, the banking client application 265 is supported by a separate computing system comprising one or more servers, processors, network interface modules, etc. that transmit the application for use to the user device 110. In certain arrangements, the banking client application 265 includes an Application Programming Interface (API) and/or a Software Development Kit (SDK) that facilitate integration of other applications. All such variations and combinations are intended to fall within the spirit and scope of the present disclosure.

The banking client application 265 is communicably coupled to the financial institution computing system 242 (e.g., the account database 250) via the network 202 and is structured to permit management of at least one account of the customer 101 via the banking client application 265. In this regard, the banking client application 265 provides displays indicative of account information such as, but not limited to, current account balances, pending transactions, profile information (e.g., contact information), investment portfolio allocation, and/or the like.

As mentioned herein, via the banking client application 265, the customer 101 can manage one or more accounts associated with the financial institution 140 (e.g., a brokerage account). In addition, the customer 101 interacts with the financial institution 214 via the banking client application 265. Accordingly and as shown, the mobile banking client application 265 includes an interaction circuit 214. The interaction circuit 214 is configured to send messages to and receive messages from the financial institution 140 (e.g., requests for a financial service, as described above). In some embodiments, the customer 101 types a message via the banking client application 265 and sends the message to the financial institution computing system 242, and the customer 101 receives a response message from the financial institution computing system 242 via the banking client application 265. In some embodiments, the customer 101 sends and receives voice messages. In some embodiments, the messages generated at the interaction circuit 214 are sent via the communication network 120 and are received by the contextual data analysis circuit 260 for analysis as described above.

In some embodiments, the web application 280 and/or the email application 290 is a server-based application executable on the user device 110. In this regard, the customer 101 can first download the applications prior to usage. In another arrangement, the web application 270 and/or the email application 290 is coded into the memory 204 of the user device 110. In still another arrangement, the web application 280 and/or the email application 290 is a web-based interface application. In this configuration, the customer 101 has to log onto or access the web-based interface before usage. In this regard, the web application 280 and/or the email application 290 is supported by a separate computing system comprising one or more servers, processors, network interface modules, etc. that transmit the application for use to the user device 110. In certain arrangements, the web application 280 and/or the email application 290 includes an Application Programming Interface (API) and/or a Software Development Kit (SDK) that facilitate integration of other applications. All such variations and combinations are intended to fall within the spirit and scope of the present disclosure.

In some embodiments, the customer 101 accesses the web application 280 to communicate with the financial institution 140. In some embodiments, the web application 280 is a web browser for generally browsing the internet or for accessing the banking client application 265, while the banking client application 265 is a mobile application (e.g., an app that is web-based) for a mobile phone that is associated with the financial institution 140. In some embodiments, the web application 280 can be used instead of the banking client application 265 to directly interface with a web-based banking application or service. For example, the customer 101 accesses a website associated with the financial institution 140 to access a financial account of the customer 101. In addition, in some embodiments, the customer 101 can send a message to or receive a message from the financial institution 140, similar to the way described above with respect to the banking client application 265. Furthermore, in some embodiments, a message sent from the web application 280 to the financial institution computing device 242 is received by the contextual data analysis circuit 260 for context analysis, as described above. In some embodiments, the customer 101 accesses the email application 290 to send an email message to the financial institution 140 (e.g., to an email address associated with the financial institution 140). In some embodiments, a message sent from the email application 290 to the financial institution computing device 242 is received by the contextual data analysis circuit 260 for context analysis as described above.

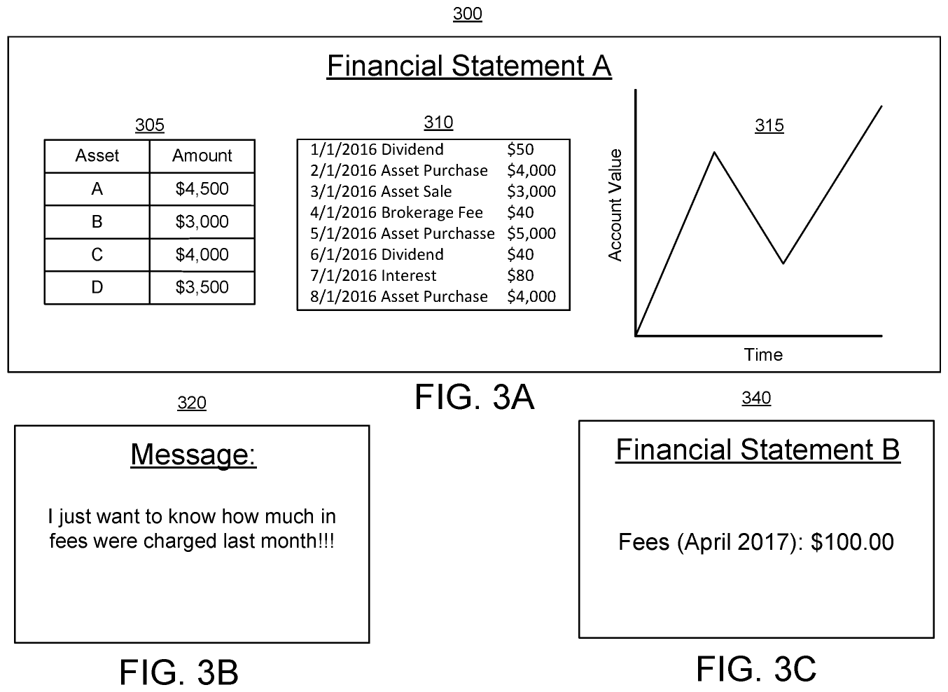

FIGS. 3A-3C are diagrams illustrating generation of financial documents by the financial institution computing system 242 according to some embodiments. Referring to FIG. 3A, the financial computing system 242 generates a financial statement 300 for the customer 101. In some embodiments, the financial statement 300 is a default financial statement that is generated in response to a customer requesting a financial statement for their account. The financial statement 300 includes several different pieces of information, including an asset table 305, a transaction history 310, and an account value graph 315. The asset table 305 illustrates assets A, B, C, D and the corresponding amounts of money held in each asset. The transaction history 310 illustrates various transactions undertaken by the account associated with the financial statement 300. For example, the transaction history 310 illustrates, from left to right, dates of transactions, types of transactions, and amounts of the transactions. The account value graph 315 illustrates the value of the account associated with the financial statement 300 over time.

Referring to FIG. 3B, a customer 101 may be overwhelmed with the amount of information depicted in the financial statement 300, and respond with a message 320. In some embodiments, the message 320 is generated at the user device 110 (e.g., from the banking client application 265, web application 280, or email application 290) and transmitted to the financial institution computing system 242. The message 320 is analyzed by the contextual data analysis circuit 260 to determine an emotional state of the customer 101. Because the message contains multiple indications of irritation (e.g., the word “just” and the multiple exclamation points), the contextual data analysis circuit 260 determines that the customer 101 is in an irritated emotional state.

Referring to FIG. 3C, in some embodiments, the service customization circuit 270 generates a new financial statement 340 in response to the determined emotional state of the customer 101. Because the customer 101 is determined to be irritated, the service customization circuit 270 construes the message 320 very strictly and generates a financial statement 340 that includes only the information that the customer 101 has asked for, with no extra information to address the customer's 101 concern and to potentially reduce the irritation of the customer 101. Accordingly, the financial statement 340 simply illustrates the total fees for April 2017, as the customer 101 indicated a desire to see in the message 320.

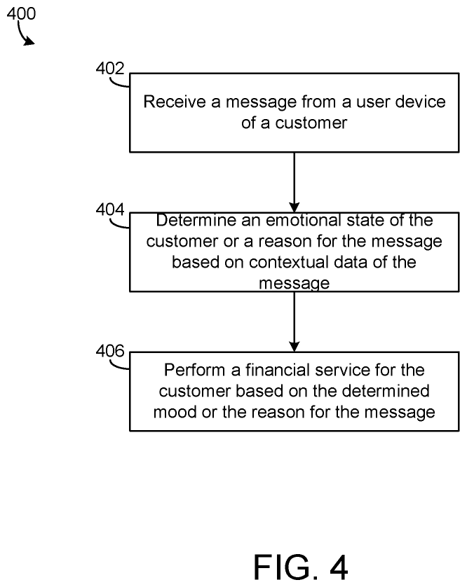

FIG. 4 is a flowchart of a method 400 for customizing financial services according to some embodiments. The method 400 is performed by a financial institution computing system (e.g., the financial institution computing system 140 of FIGS. 1 and 2).

In some embodiments, at step 402, a message from a user device of a customer is received. In certain embodiments, the message is received at the contextual data analysis circuit 260. In some embodiments, the user device 110 sends the message via telephone, the banking client application 265, the web application 280, or the email application 290. In some embodiments, the message is a voice message or a text-based message.

In some embodiments, at step 404, an emotional state of the customer or a reason for the message based on contextual data of the message is determined. In certain embodiments, the contextual data analysis circuit 260 analyzes the message for contextual data. In some embodiments, the contextual data of the message includes a tone of voice, body language, syntax, diction, facial expressions, volume of a voice, use of punctuation, and capitalization. In some embodiments, the determined emotional state includes one or more of nervous, sad, excited, happy, aggravated, confused, calm, complacent, cynical, disappointed, frustrated, satisfied, and uncomfortable. In some embodiments, the emotional state of the customer or the reason for the message is determined further based on social media data of the customer.

In certain embodiments, at step 406, a financial service for the customer is performed based on the determined emotional state or the reason for the message. In some embodiments, the financial service is performed or generated by the service customization circuit 270. In some embodiments, the financial service is provided at the user device 110. In some embodiments, the financial service includes generating a financial statement or document based on the emotional state of the customer. In some embodiments, the financial service includes suggesting financial services or products based on the emotional state of the customer 101 or on the reason the customer 101 sent the message. In one example, a financial service can include changing a physical mailing address of a customer such that mailed documents are sent to the new mailing address (e.g., rather than to the old mailing address).

Certain embodiments include non-transitory computer readable media having computer-executable instructions embodied therein that, when executed by financial institution computing system 140, including certain instructions executed by customer metric management circuit 260, causes the financial institution computing system 140 to perform operations described herein, or any operations that may be performed by any embodiments of financial institution computing system 140.

Certain embodiments described herein have been described with reference to drawings. The drawings illustrate certain details of embodiments that implement example systems, methods, non-transitory computer readable media having computer-executable instructions, and programs described herein. However, describing example embodiments with drawings should not be construed as imposing on the disclosure any limitations that may be present in the drawings. For example, elements shown in drawings may or may not be included in embodiments of the systems and methods herein.

It should be understood that no claim element herein is to be construed under the provisions of 35 U.S.C. § 112(f), unless the element is expressly recited using the phrase “means for.”

It should be further understood that “or” should be construed as inclusive or, such that, for example, “A or B” means A, B, or A and B, and for example, “A, B, or C” means A, B, C, or any combination thereof (e.g., A and B, A and C, B and C).

It should be further understood that a database that may be described as two or more databases in the example embodiments or claims may be implemented as one database. It should be further understood that a database that may be described as one database in the example embodiments or claims may be implemented as two or more databases. It should be further understood that a circuit that may be described as two or more circuits in the example embodiments or claims may be implemented as one circuit. It should be further understood that a circuit that may be described as one circuit in the example embodiments or claims may be implemented as two or more circuits.

It should be further understood that “a” and “an” are not limited to a single instance and should be construed as “one or more,” such that, for example, a database “storing information of a transaction” is a database storing information of one or more transactions.

As used herein, the term “circuit” may include hardware structured to execute the functions described herein. In some embodiments, each respective “circuit” may execute, or include machine-readable media for configuring the hardware to execute, the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices, including but not limited to devices such as those described herein, any other input devices capable of performing a similar function, and any other input devices that may be used with a computing device. Comparatively, the term “output device,” as described herein, may include any type of output device or output devices, including but not limited to devices such as those described herein, any other output devices capable of performing a similar function, and any other output devices that may be used with a computing device.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined and form part of the same step, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of example embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain examples of the disclosure and its practical application to enable one skilled in the art to utilize various embodiments and with various modifications as may be suited to any particular use contemplated. Other substitutions, modifications, changes, and omissions may be made in the design, operating conditions, and arrangement of the embodiments without departing from the scope of the present disclosure as expressed in the appended claims.

1. A financial institution computing system comprising:
a network interface;
a contextual data analysis circuit configured to:
receive, via the network interface, a first electronic message from a user device of a customer;
access one or more social media accounts associated with the customer;
analyze activity associated with the customer on the one or more social media accounts;
determine a customer influence level based at least in part on the analysis;
extract contextual data from the first electronic message and the one or more social media accounts, the contextual data including at least one of audio or video data of the customer;
parse the contextual data into words and phrases;
cross-reference the words and phrases with a contextual data templates database;
determine an emotional state of the customer based at least on parsed words and phrases being cross-referenced to the contextual data templates database, further comprising operations to:
compare the at least one of the audio or video data to a plurality of templates from the contextual data templates database, each template indicating a behavior that corresponds to an emotional state; and
determine whether a volume associated with the audio data from the contextual data or with audio associated with the video data from the contextual data exceeds a predetermined decibel threshold indicative of a negative emotional state;
determine that a life event has occurred for the customer based on the contextual data extracted from the one or more social media accounts;
determine a reason for the first electronic message based at least partially on the determined life event; and
when the determined emotional state comprises the negative emotional state, generate an incentive for the customer, wherein the incentive corresponds to the determined customer influence level; and
a service customization circuit configured to:
determine a financial service to perform for the customer based on the reason for the first electronic message, wherein the financial service comprises at least one of generating a financial statement for the customer, generating a document reflecting information of an account of the customer, providing a form to the customer, changing a mailing address of the customer, reversing a fee charged to the customer, opening a new account for the customer, closing an account of the customer, depositing funds to an account of the customer, withdrawing funds from an account of the customer, and modifying investment allocations of assets of an account of the customer;
customize the financial service for the customer based on: i) the parsed words and phrases, ii) the determined emotional state of the customer, iii) the reason for the first electronic message, and iv) the determined customer influence level, wherein customization includes the customer incentive, and wherein customization of the financial service for the customer comprises operations to:
generate a second electronic message regarding the customized first financial service, wherein the second electronic message is optimized by omitting information determined to be impertinent based at least on the parsed words and phrases; and
transmit, to the display of the user device of the customer, via the network interface, the second electronic message;
topically aggregate additional financial services based on a predictive analysis of the contextual data by the contextual data analysis circuit, wherein topical aggregation operations are structured to decrease subsequent customer inquiries into a topic; and
generate and transmit, via the network interface, to the user computing device a third electronic message structured to suggest one or more additional financial services to the customer from the topical aggregation.

2. The financial institution computing system of claim 1, wherein the first electronic message is one of a voice message, an electronic message, or an interaction at a financial institution associated with the financial institution computing system.

3. The financial institution computing system of claim 1, wherein the at least one of the audio or visual data includes one or more of a tone of voice, body language, syntax, diction, facial expressions, volume of a voice, use of punctuation, and capitalization.

4. The financial institution computing system of claim 1, wherein the one or more characteristics of the first electronic message include a time of year and a historical characteristic of the customer.

5. The financial institution computing system of claim 1, wherein the determined emotional state includes one or more of nervous, sad, excited, happy, aggravated, confused, calm, complacent, cynical, disappointed, frustrated, satisfied, and uncomfortable.

6. The financial institution computing system of claim 1, wherein the reason for the first electronic message is determined to be opening a new account, and the customized financial service includes a suggestion of opening a different type of account that is related to the new account.

7. The financial institution computing system of claim 1, wherein the first electronic message includes a request to receive a financial statement including specific information with respect to an account of the customer.

8. The financial institution computing system of claim 7, wherein the financial service includes generating the financial statement consisting of the requested specific information.

9. (canceled)

10. (canceled)

11. A method performed by a financial institution computing system, the method comprising:
receiving, by a contextual data analysis circuit, and via a network interface, a first electronic message from a user device of a customer;
accessing, by the contextual data analysis circuit, one or more social media accounts associated with the customer;
analyzing, by the contextual data analysis circuit, activity associated with the customer on the one or more social media accounts;
determining, by the contextual data analysis circuit, a customer influence level based at least in part on the analysis;
extracting, by the contextual data analysis circuit, contextual data from the received first electronic message and the one or more social media accounts, the contextual data including at least one of audio or visual data of the customer;
parsing, by the contextual data analysis circuit, the contextual data into words and phrase;
cross-referencing, by the contextual data analysis circuit, the words and phrases with a contextual data templates database;
determining, by the contextual data analysis circuit, an emotional state of the customer based at least on parsed words and phrases being cross-referenced to the contextual data templates database, further comprising operations for:
comparing the at least one of the audio or video data to a plurality of templates from the contextual data templates database, each template indicating a behavior that corresponds to an emotional state; and
determining whether a volume associated with the audio data from the contextual data or with audio associated with the video data from the contextual data exceeds a predetermined decibel threshold indicative of a negative emotional state;
determining, by the contextual data analysis circuit, that a life event has occurred for the customer based on the contextual data extracted from the one or more social media accounts;
determining, by the contextual data analysis circuit, a reason for the first electronic message based at least partially on the determined life event;
subsequent to determining that the emotional state comprises the negative emotional state, generating an incentive for the customer, wherein the incentive corresponds to the determined customer influence level;
determining, by a service customization circuit, a financial service to perform for the customer based on the reason for the first electronic message, wherein the financial service comprises at least one of generating a financial statement for the customer, generating a document reflecting information of an account of the customer, providing a form to the customer, reversing a fee charged to the customer, opening a new account for the customer, closing an account of the customer, depositing funds to an account of the customer, withdrawing funds from an account of the customer, and modifying investment allocations of assets of an account of the customer;
customizing, by the service customization circuit, the financial service for the customer based on i) the parsed words and phrases, ii the determined emotional state of the customer, iii) the reason for the first electronic message, and iv) the determined customer influence level, wherein customization includes the customer incentive, and wherein customization of the financial service for the customer comprises operations for:
generating a second electronic message regarding the customized first financial service, wherein the second electronic message is optimized by omitting information determined to be impertinent based at least on the parsed words and phrases; and
transmitting, to the display of the user device of the customer, via the network interface, the second electronic message;
topically aggregating, by the service customization circuit, additional financial services based on a predictive analysis of the contextual data by the contextual data analysis circuit, wherein topical aggregation operations are structured to decrease subsequent customer inquiries into a topic; and
generating and transmitting to the user computing device associated with the customer, by the service customization circuit, and via the network interface, a third electronic message structured to suggest one or more additional financial services to the customer from the topical aggregation.

12. The method of claim 11, wherein the first electronic message is one of a voice message, an electronic message, or an interaction at a financial institution associated with the financial institution computing system.

13. The method of claim 11, wherein the contextual data includes one or more of a tone of voice, body language, syntax, diction, facial expressions, volume of a voice, use of punctuation, and capitalization.

14. The method of claim 11, wherein the customized financial service further includes a suggestion of other financial services that are related to a content of the first electronic message.

15. The method of claim 11, wherein the determined emotional state includes one or more of nervous, sad, excited, happy, aggravated, confused, calm, complacent, cynical, disappointed, frustrated, satisfied, and uncomfortable.

16. The method of claim 11, wherein the reason for the first electronic message is determined to be to open a new account, and the customized financial service includes a suggestion of opening a different type of account that is related to the new account.

17. The method of claim 11, wherein the first electronic message includes a request to receive a financial statement including specific information with respect to an account of the customer.

18. The method of claim 17, wherein the financial service includes generating the financial statement consisting of the requested specific information.

19. (canceled)

20. A non-transitory computer readable medium having computer-executable instructions embodied therein that, when executed by a contextual data analysis circuit and a service customization circuit of a financial institution computing system, cause the financial institution computing system to perform operations, the operations comprising:
receiving, by the contextual data analysis circuit, via a network interface, a first electronic message from a user device of a customer;
accessing, by the contextual data analysis circuit, one or more social media accounts associated with the customer;
analyzing, by the contextual data analysis circuit, activity associated with the customer on the one or more social media accounts;
determining, by the contextual data analysis circuit, a customer influence level based at least in part on the analysis;
extracting, by the contextual data analysis circuit, contextual data from the received first electronic message and the one or more social media accounts, the contextual data including at least one of audio or visual data of the customer;
parsing, by the contextual data analysis circuit, the contextual data into words and phrase;
cross-referencing, by the contextual data analysis circuit, the words and phrases with a contextual data templates database;
determining, by the contextual data analysis circuit, an emotional state of the customer based at least on parsed words and phrases being cross-referenced to the contextual data templates database, further comprising operations for:
comparing the at least one of the audio or video data to a plurality of templates from the contextual data templates database, each template indicating a behavior that corresponds to an emotional state; and
determining whether a volume associated with the audio data from the contextual data or with audio associated with the video data from the contextual data exceeds a predetermined decibel threshold indicative of a negative emotional state;
determining, by the contextual data analysis circuit, that a life event has occurred for the customer based on the contextual data extracted from the one or more social media accounts;
determining, by the contextual data analysis circuit, a reason for the first electronic message based at least partially on the determined life event;
subsequent to determining that the emotional state comprises the negative emotional state, generating an incentive for the customer, wherein the incentive corresponds to the determined customer influence level;
determining, by the service customization circuit, a financial service to perform for the customer based on the reason for the first electronic message, wherein the financial service comprises at least one of generating a financial statement for the customer, generating a document reflecting information of an account of the customer, providing a form to the customer, reversing a fee charged to the customer, opening a new account for the customer, closing an account of the customer, depositing funds to an account of the customer, withdrawing funds from an account of the customer, and modifying investment allocations of assets of an account of the customer;
customizing, by the service customization circuit, the financial service for the customer based on: i) the parsed words and phrases, ii the determined emotional state of the customer, iii) the reason for the first electronic message, and iv) the determined customer influence level, wherein customization includes the customer incentive, and wherein customization of the financial service for the customer comprises operations for:
generating a second electronic message regarding the customized first financial service, wherein the second electronic message is optimized by omitting information determined to be impertinent based at least on the parsed words and phrases; and
transmitting, to the display of the user device of the customer, via the network interface, the second electronic message;
topically aggregating, by the service customization circuit, additional financial services based on a predictive analysis of the contextual data by the contextual data analysis circuit, wherein topical aggregation operations are structured to decrease subsequent customer inquiries into a topic; and
generating and transmitting to the user computing device associated with the customer, by the service customization circuit, and via the network interface, a third electronic message structured to suggest one or more additional financial services to the customer from the topical aggregation.
